(19) United States
(12) Patent Application Publication
(10) Pub. No.: US 2014/0289674 A1
(43) Pub. Date: Sep. 25, 2014

(54) APPARATUS AND METHOD FOR MANAGING SHORTCUT MENU OF APPLICATIONS

(71) Applicant: Samsung Electronics Co., Ltd., Suwon-si (KR)

(72) Inventors: Pyeong-Gyu JIN, Suwon-si (KR); Yoon-Jeong CHOI, Seoul (KR)

(73) Assignee: Samsung Electronics Co., Ltd., Suwon-si (KR)

(21) Appl. No.: 14/222,016

(22) Filed: Mar. 21, 2014

(30) Foreign Application Priority Data
Mar. 21, 2013 (KR) 10-2013-0030538

(51) Int. Cl. G06F 9/54; G06F 3/0482

(52) U.S. Cl. CPC G06F 9/542; G06F 3/0482
USPC 715/810; 719/318

(57) ABSTRACT

An apparatus and method for managing shortcut menus of applications are provided. The method includes determining whether an event for an application is generated, calculating accumulation points for the application based on a type of the event that is generated when the event is generated, and applying a first visual effect to a shortcut menu of the application based on the accumulation points. Accordingly, there is an advantage in that a user may recognize applications which have a low or high use frequency.

### PRIORITY

This application claims the benefit under 35 U.S.C. §119(a) of a Korean patent application filed on Mar. 21, 2013 in the Korean Intellectual Property Office and assigned Serial No. 10-2013-0030538, the entire disclosure of which is hereby incorporated by reference.

### BACKGROUND OF THE INVENTION

1. Field of the Invention

The present invention relates to an apparatus and method for managing a shortcut menu of applications.

2. Description of the Related Art

With the recent development of multimedia techniques and services, a variety of terminals, such as smart phones and the like, have been in wide use. Such terminals have a variety of applications stored therein and provide shortcut menus of various applications on a background screen for user's convenience. These shortcut menus are typically provided in the form of icons. To satisfy a user's needs and improve the performance of a terminal, a large number of applications are stored in the terminal, and also shortcut menus displayed on a background screen of the terminal are increasing.

A user who installs and uses a variety of applications may not recognize if any specific application, from among the variety of applications installed on the terminal, is stored in the terminal. Further, the user may not know if any application is frequently used or not. Accordingly, after identifying information on each application one by one, the user should individually delete shortcut menus of the applications. Otherwise, many shortcut menus are displayed on a background screen, resulting in a poor user experience.

The above information is presented as background information only to assist with an understanding of the present disclosure. No determination has been made, and no assertion is made, as to whether any of the above might be applicable as prior art with regard to the present invention.

### SUMMARY OF THE INVENTION

Aspects of the present invention are to address at least the above-mentioned problems and/or disadvantages and to provide at least the advantages described below. Accordingly, an aspect of the present invention is to provide a scheme in which a user facilitates the management of shortcut menus of applications.

In accordance with an aspect of the present invention, a method of managing shortcut menus of applications in an electronic device is provided. The method includes determining whether an event for an application is generated, calculating accumulation points for the application based on a type of the event that is generated when the event is generated, and applying a first visual effect to a shortcut menu of the application based on the accumulation points.

In accordance with another aspect of the present invention, an apparatus for managing shortcut menus of applications in an electronic device is provided. The apparatus includes a display unit displaying at least one shortcut menu of an application and a controller determining whether an event for an application is generated, calculating accumulation points for the application based on a type of the event that is generated when an event is generated, and applying a first visual effect to the shortcut menu of the application based on the calculated accumulation points.

According to an aspect of the present invention, there is an advantage in that a user may easily identify applications that are frequently or infrequently used. Further, there is an advantage in that a user may easily delete applications which are infrequently used.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIG. 1 is a flowchart illustrating a method of managing a shortcut of an application according to an exemplary embodiment of the present invention;

FIGS. 2A, 2B and 3 are exemplary views illustrating visual effects according to exemplary embodiments of the present invention;

FIGS. 4A and 4B are views illustrating a process of deleting a shortcut menu according to an exemplary embodiment of the present invention; and

FIG. 5 is a block diagram illustrating a terminal to which the exemplary embodiments of the present invention are applied.

Throughout the drawings, it should be noted that like reference numbers are used to depict the same or similar elements, features, and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions may be omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

Hereinafter, the exemplary embodiments of the present invention will be described with reference to the accompanying drawings.

An electronic device herein is any device, which may also be referred to as a portable terminal, a mobile terminal, a communication terminal, a portable communication terminal, or a portable mobile terminal. For example, an electronic device includes a smartphone, a portable phone, a game console, a TeleVision (TV), a display device, a head unit for a vehicle, a laptop computer, a tablet Personal Computer (PC), a Personal Media Player (PMP), a Personal Digital Assistant (PDA), a navigator, an Automatic Teller Machine (ATM) of a bank, and a Point Of Sale (POS) device of a shop. In the present invention, an electronic device is a flexible device or a flexible display device.

The following description will be given with the appreciation that a terminal is being used as an electronic device and some components are omitted or modified in the general configuration of the electronic device.

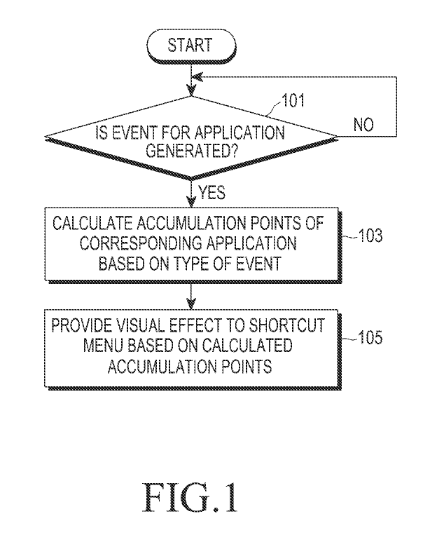

FIG. 1 is a flowchart illustrating a method of managing a shortcut menu of an application according to an exemplary embodiment of the present invention.

In step 101, a terminal determines whether an event is generated for an application. Where the event for the application is generated, the terminal proceeds to step 103. Here, the event of the application may be related to at least one of an execution, initialization, termination, and push notification of the application.

An event related to the execution and/or initialization of the application may be a case where a shortcut of an application displayed on a background screen or an application from an application list provided in a form of a separate menu is selected in order to execute the corresponding application, or may be a case where one application seeks to obtain information managed by another application and makes a request for authority to access another application. For example, the event related to the execution and/or initialization of the application may be a case where an application A requests that application B, which manages image files, shares information on the image files when application A performs an image transmission function.

On the other hand, in a case in which an event relating to the termination of the application is generated, a user requests the terminal to finish an operation of the application which is being used. At this time, an operated application may mean an application which is automatically operated during booting of the terminal and on a background, or which is operated according to a selection of a user.

Further, a case in which an event relating to a generation of a push notification of an application may be a case where a push message for a corresponding application arrives according to the settings of push notifications for the corresponding application. For example, if a service program corresponding to a certain application operates on or in a background, the notifying of the push may be a case where the corresponding service program transmits the push notification to the corresponding application.

In step 103, the terminal calculates accumulation points of a corresponding application based on a type of the generated event, and proceeds to step 105. That is, the terminal manages the accumulation points of each application based on usage of an application such as execution and termination of the application, a push notification, and the like. In other words, accumulation points of the corresponding application indicate a number of times an event, such as an execution, initialization, termination, and push notification of the corresponding application occur. In an exemplary embodiment, the terminal may give a predetermined number of points to each event and calculate the accumulation points for each application. According to the exemplary embodiment, a user may change the number of points given to each type of event.

As described above, the terminal adds or subtracts the predetermined point to/from each event so as to calculate the accumulation points for a corresponding application. For example, 1 point may be set for an event relating to the execution of the application and a push notification, and −1 point may be set for an event relating to the termination of the application. Accordingly, the terminal may add 1 accumulation point for the corresponding application when the event relating to the execution of the application and a push notification is generated, and may subtract 1 accumulation point for the corresponding application when the event relating to the termination of the application is generated.

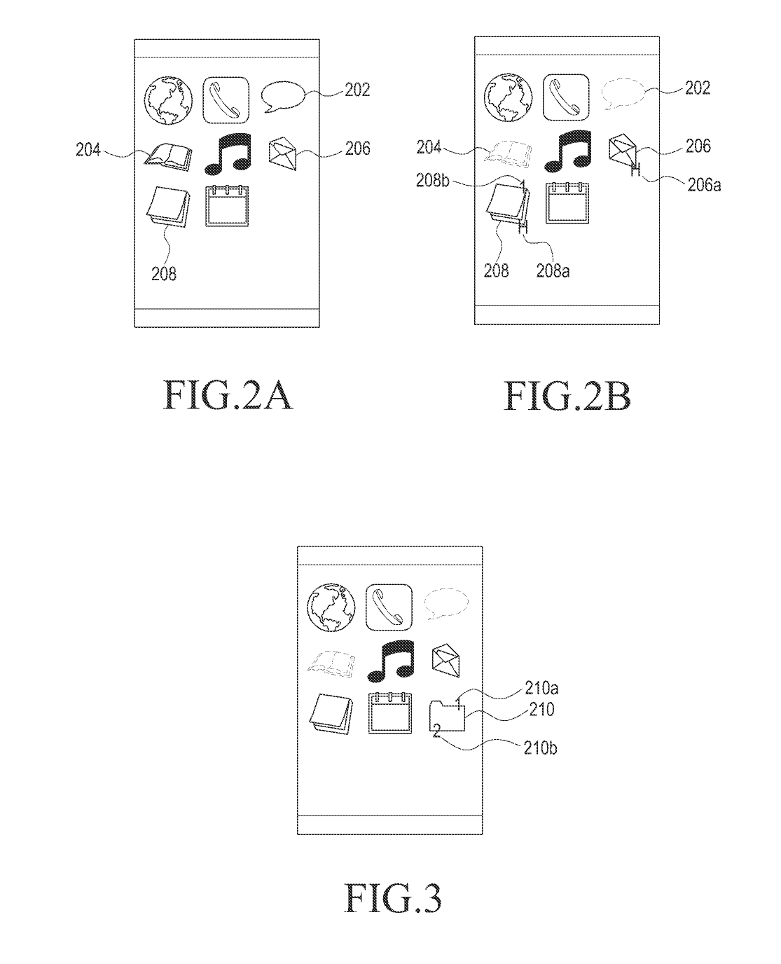

In step 105, the terminal applies a visual effect to the shortcut menu of the corresponding application based on the calculated accumulation points. The visual effect may be an increase or decrease in an opacity of the shortcut menu of the corresponding application, may be displaying of an image to correspond to the shortcut menu of the corresponding application, or may be any similar and/or suitable visual effect applied and/or corresponding to the shortcut menu. The visual effect will be described with reference to FIGS. 2A and 2B as follows.

FIGS. 2A, 2B and 3 are exemplary views illustrating visual effects according to exemplary embodiments of the present invention.

Referring to FIGS. 2A, 2B, and 3, it is assumed that shortcut menus of a plurality of application 202, 204, 206, and 208, which also may be referred to as icon applications 202, 204, 206, and 208 and/or images, are displayed, as shown in FIG. 2A, according to a condition that the accumulation points for the applications installed on the terminal are identical. However, the present invention is not limited thereto, and a plurality of application icons may be displayed according to a variety of conditions, such as the accumulation points for the applications being approximately identical, or any other similar and/or suitable condition for determining a plurality of applications to be displayed. Additionally, accumulation points may be compared to a reference point, the reference point being a predetermined point before calculating the accumulation points. In a case where the application 202 and 204 obtain accumulation points resulting from events relating to the execution and termination of the application and the generation of a push notification such that the obtained accumulation points are lower than the reference point, and the applications 206 and 208 gain accumulation points higher than the reference point, the terminal may apply the visual effect to the shortcut menus of the applications 202, 204, 206 and 208.

For example, as shown in FIG. 2B, the terminal enables predetermined images 206a and 208a to overlap the shortcut menus of the applications 206 and 208, which have a higher number of accumulation points than the reference point. At this time, the terminal may allow a user to know which application has the highest number of accumulation points. For example, the terminal may display a numeral as the image 208b or an image indicating a use frequency ranking of the corresponding application. According to the present exemplary embodiment, displaying of the numeral or image indicating the use frequency ranking may be applied to the shortcut menus of the predetermined number of applications.

As shown in FIG. 2B, the terminal may decrease the opacity of the shortcut menus of the applications 202 and 204 having a lower number of accumulation points than the reference point. The decrease in the opacity may be achieved by reducing the opacity of icons of the shortcut menus of the corresponding application by a predetermined value each time the number of accumulation points of the corresponding application is reduced by a predetermined value. For example, when the accumulation points of the corresponding application is reduced by 1 point, the opacity of the icons the shortcut menu of the corresponding application may be decreased by 1 point. On the contrary, when the accumulation points of the corresponding application increases by 1 point, the terminal may increase the opacity of the icons of the shortcut of the corresponding application by 1 point. In the present exemplary embodiment, the increase and decrease in the opacity may be established by applying an alpha blending method. On the other hand, instead of decreasing the opacity of the icons of the shortcut menu of the application having the lower number of accumulation points than the reference point, the terminal may enable a predetermined image to overlap the icon of the shortcut menu of the corresponding application and may display the icon of the shortcut menu to be overlapped with the image so as to inform the user that the use frequency of the application is low.

According to another exemplary embodiment, the decrease in the opacity and the application of the predetermined image may be achieved with relation to only the shortcut menus of the designated number of applications. That is, they may be achieved only for the shortcut menus of some applications having the low use frequency. According to the present exemplary embodiment, as described above with reference to FIG. 1, the terminal has an advantage in that it is possible to inform the user that an application has a lower or higher use frequency than other applications.

On the other hand, the shortcut menus of the applications may be disposed in a folder, and the folder may be displayed on the background screen. In a case where the shortcut menus of the applications to which the visual effect is applied are disposed in a corresponding folder, a visual effect should also be applied to the corresponding folder so that the terminal informs the user that the application to which the visual effect is applied, i.e. the shortcut menu of the application having a low or high use frequency, is in the corresponding folder. This will be described with reference to FIG. 3.

For example, FIG. 3 illustrates a case where three or more shortcut menus of applications are disposed in a folder 210, and an application from among the three applications has a higher number of accumulation points than a reference point and the remaining two applications have a lower number of accumulation points than the reference point. In this case, the terminal may display the numbers 210a of the applications having the higher number of accumulation points than the reference point and the numbers 210b of the applications having the lower number of accumulation points than the reference point on an image of the folder 210 by making them overlap the image of the folder 210.

According to the another exemplary embodiment of the present invention, only the numbers of the shortcut menus of the applications which have the use frequency ranking in a predetermined order, from among the applications having a higher number of accumulation points than the reference point, may be displayed. Alternatively, only the numbers of the shortcut menus of the applications, which have the use frequency ranking in a predetermined order, from among the applications having a lower number of accumulation points than the reference point, may be displayed. According to another exemplary embodiment of the present invention, instead of displaying the numbers of the applications having the low or high use frequency, an image which informs the user that the applications are disposed in the corresponding folder and that overlaps the corresponding folder image may be displayed.

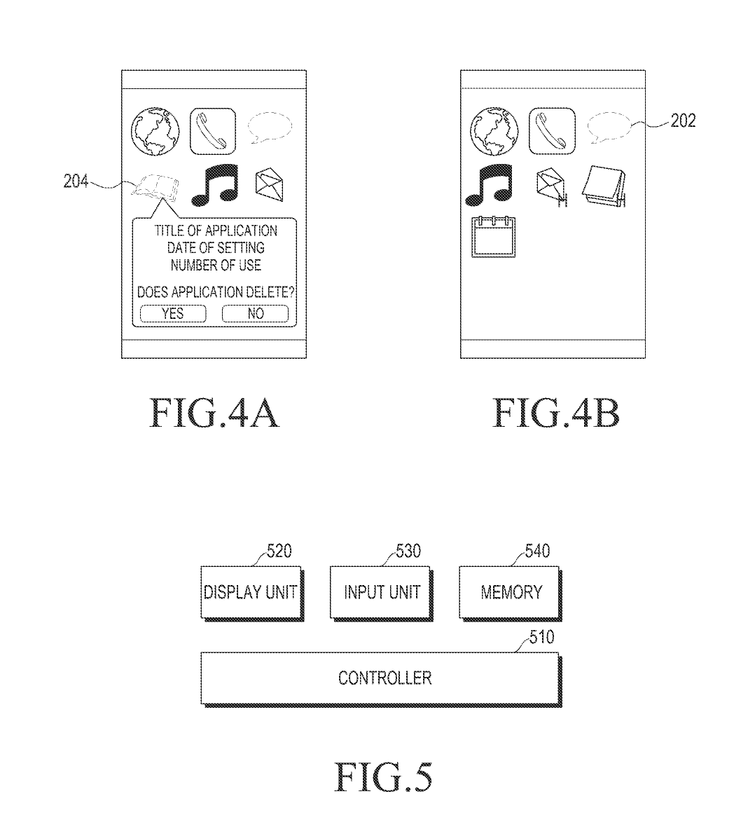

The shortcut menus of the applications of which the opacity, i.e. the use frequency, is lowered may be deleted, or removed from, or not shown in the background screen for a user's convenience. A method of deleting the shortcut menus of the applications may be described with reference to FIGS. 4A and 4B.

FIGS. 4A and 4B are views illustrating a process of deleting a shortcut menu according to an exemplary embodiment of the present invention.

As shown in FIG. 4A, when the user selects a shortcut menu of an application 204 which has a lower opacity than a predetermined value, the terminal may display a message having information on the corresponding application and asking if the corresponding application, that being application 204 in the present exemplary embodiment, should be deleted. When the user selects the deletion of the shortcut menu of the corresponding application in response to the displayed message, then the terminal deletes the shortcut menu of the corresponding application and rearranges the remaining shortcut menus of the applications, as shown in FIG. 4B.

According to the present exemplary embodiment, when the user selects the shortcut menu of the application having the lower opacity than the predetermined value, then the terminal may display the information on the corresponding application, and may then automatically delete the shortcut menu of the corresponding application. According to another exemplary embodiment, when the user selects the shortcut menu of the application having the lower opacity than the predetermined value, the terminal may also immediately delete the shortcut menu of the corresponding application.

In the calculation of the accumulation points for each application, an operation time through which each application operates may be reflected in the accumulation points for the corresponding application. The operation time may be a period of time from an execution start event of the application to an execution finish or termination event of the application. At this time, the terminal may give more points to the corresponding application as the operation time becomes longer, and may calculate the accumulation points. For example, the terminal adds 1 point when the application operates for an hour, and 2 points when the application operates for two hours, so as to calculate the accumulation points for the corresponding application.

The method of managing a shortcut menu of an application in a terminal according to the exemplary embodiments of the present invention has been described with reference to FIGS. 1 to 4B. Hereinafter, a configuration of the terminal to which the exemplary embodiments of the present invention are applied will be described with reference to FIG. 5.

FIG. 5 is a block diagram illustrating the terminal to which the exemplary embodiments of the present invention are applied.

Referring to FIG. 5, the terminal to which the exemplary embodiments of the present invention are applied includes a controller 510, a display unit 520, an input unit 530, and a memory 540.

The controller 510 determines whether an event, such as an execution, initialization, termination, and push notification, for an application is generated, and calculates accumulation points for the corresponding application based on a type of the event when the event is generated. Then, the controller 510 applies a first visual effect to a shortcut menu of the corresponding application based on the calculated accumulation points. Here, the type of the event may include at least one of an execution, initialization, and push notification of the application.

During the calculation of the accumulation points for each application, the controller 510 may increase the accumulation points for the corresponding application by a predetermined value if the event relates to the execution of the application or the generation of a push notification, and may decrease the accumulation points for the corresponding application if the event relates to the termination of the application.

The controller 510 reduces opacity of the shortcut menu of the corresponding application if the application has a low number of accumulation points, so as to provide the first visual effect. At this time, when the user selects the shortcut menu of which the opacity is lowered by the predetermined value, the controller 510 displays information on the application corresponding to the shortcut menu, and displays a message asking whether the corresponding shortcut menu will be deleted. When a request for the deletion of the shortcut menu is made, then the controller deletes the corresponding shortcut menu and arranges the remaining shortcut menus.

The controller 510 determines a ranking of the applications based on the accumulation points, makes a predetermined image overlap on the shortcut menu of the applications according to the determined ranking, and displays the shortcut menu overlapped with the predetermined image, so as to apply the first visual effect. In a case where the application to which the first visual effect is applied is disposed in a folder, then the controller 510 applies a second visual effect to an image of the folder.

The controller 510 makes at least one of an image for notifying that the shortcut menu to which the first visual effect is applied is present in the corresponding folder, and an image for notifying the number of the shortcut menus to which the first visual effect is applied from among the shortcut menus disposed in the corresponding folder. Additionally, the controller 510 overlaps the image of the corresponding folder, and displays the overlapped image of the corresponding folder so as to provide the second visual effect. The controller 510 calculates an operation time from a start, or execution, to a finish, or termination, of an application, and counts accumulation points for the corresponding application in consideration of the operation time. At this time, the controller 510 may give more points as the operation time becomes longer.

The display unit 520 displays at least one shortcut menu of the application. Further, the display unit 520 applies a predetermined visual effect to the shortcut menu of each application, and displays the shortcut menu, under a control of the controller 510.

The input unit 530 is used to receive inputs for an execution and a termination of an application from the user. Further, the input unit 530 receives inputs for various settings, such as a setting for a push notification, for an application from the user. Input information is transmitted to the controller 510.

The memory 540 stores the applications, the visual images for the shortcut menus of the applications, i.e. icons, and any other similar and/or suitable information to be displayed on the display unit or used in the operations of the exemplary embodiments described above. Further, the memory 540 stores settings and images with relation to various kinds of visual effects to be applied to the shortcut menus of the applications.

It will be appreciated that exemplary embodiments of the present invention may be implemented in the form of hardware, software, or a combination of hardware and software. In a case where exemplary embodiments of the present invention may be implemented in software, the software may be executed by one or more processors using various operating systems or platforms. In addition, the software may be programmed by using any one of a variety of suitable programming languages, and also may be compiled into assembly codes or intermediate codes which can be carried out in a framework or a virtual machine.

Furthermore, exemplary embodiments of the present invention may be implemented by a processor-readable and/or computer-readable non-volatile storage medium, for example a memory, a Read-Only Memory (ROM), a Random-Access Memory (RAM), a floppy disc, a hard disc, a compact disc, an optical disc, a magnetic tape, or any other similar and/or suitable non-volatile storage medium that is suitable for storing a program or programs including instructions for implementing the exemplary embodiments of the present invention.

While the invention has been shown and described with reference to certain embodiments thereof, it will be understood by those skilled in the art that various changes in form and details may be made therein without departing from the spirit and scope of the invention as defined by the appended claims and their equivalents.

What is claimed is:

1. A method of managing shortcut menus of applications in an electronic device, the method comprising:
determining whether an event for an application is generated;
calculating accumulation points for the application based on a type of the event that is generated when the event is generated; and
applying a first visual effect to a shortcut menu of the application based on the accumulation points.

2. The method as claimed in claim 1, wherein the type of the event includes at least one of an execution, a termination, and a push notification of the application.

3. The method as claimed in claim 2, wherein the calculating of the accumulation points comprises:
increasing the accumulation points for the application by a predetermined value if the event relates to at least one of the execution of the application and the push notification, and
decreasing the accumulation points for the application by a predetermined value if the event relates to the termination.

4. The method as claimed in claim 1, wherein the applying of the first visual effect comprises decreasing opacity of the shortcut menu as a number of the accumulation points of the application become lower.

5. The method as claimed in claim 4, further comprising:
displaying an application information corresponding to the shortcut menu and displaying a message asking whether the shortcut menu will be deleted when a user selects the shortcut menu of which its opacity is lowered by a predetermined value; and
deleting the application and arranging remaining shortcut menus when a request for the deletion on the message is made.

6. The method as claimed in claim 1, wherein the applying of the first visual effect comprises:
determining a ranking order of the applications based on the accumulation points;
displaying predetermined images so as to overlap the shortcut menus of the applications according to the ranking order.

7. The method as claimed in claim 1, further comprising applying a second visual effect to an image of a folder when the application to which the first visual effect is applied is disposed in the folder.

8. The method as claimed in claim 7, wherein the applying of the second visual effect comprises:
displaying at least one of an image indicating that the shortcut menus to which the first visual effect is applied are disposed in the folder and an image indicating a number of the shortcut menus to which the first visual effect is applied,
wherein the image indicating that the shortcut menus to which the first visual effect is applied are disposed in the folder and the image indicating the number of the shortcut menus to which the first visual effect is applied overlap an image of the folder.

9. The method as claimed in claim 1, further comprising calculating an operation time from an execution of the application to a termination of the application, wherein the calculating of the accumulation points comprises calculating accumulation points for the application in consideration of the operation time.

10. The method as claimed in claim 9, where the calculating of the accumulation points comprises increasing the accumulation points as the operation time becomes longer.

11. An electronic device for managing shortcut menus of applications, the electronic device comprising:
a display unit displaying at least one shortcut menu of an application; and
a controller determining whether an event for an application is generated, calculating accumulation points for the application based on a type of the event that is generated when an event is generated, and applying a first visual effect to the shortcut menu of the application based on the calculated accumulation points.

12. The electronic device as claimed in claim 11, wherein the type of the event includes at least one of an execution, a termination, and a push notification of the application.

13. The electronic device as claimed in claim 12, wherein the controller increases a number of the accumulation points for the application by a predetermined value if the event relates to at least one of the execution of the application and a generation of the push notification, and
wherein the controller decreases the number of accumulation points for the application by a predetermined value if the event relates to the termination.

14. The electronic device as claimed in claim 11, wherein the controller reduces opacity of the shortcut menu as a number of the accumulation points of the application become lower.

15. The electronic device as claimed in claim 14, wherein the controller displays an application information on an corresponding to the shortcut menu and displays a message asking whether the shortcut menu will be deleted when a user selects the shortcut menu of which its opacity is lowered by a predetermined value, and
wherein the controller deletes the shortcut menu if a request for the deletion on the message is made, before remaining shortcut menus are arranged.

16. The electronic device as claimed in claim 11, wherein the controller determines a ranking order of the applications based on the accumulation points,
wherein the controller displays a predetermined image so as to overlap the shortcut menus of the application according to the ranking order.

17. The electronic device as claimed in claim 11, wherein the controller applies a second visual effect to an image of a folder when the application to which the first visual effect is applied is disposed in the folder.

18. The electronic device as claimed in claim 17, wherein the controller displays at least one of an image indicating that the shortcut menu to which the first visual effect is applied is disposed in the folder and an image indicating a number of the shortcut menus to which the first visual effect is applied from among the shortcut menus disposed in the folder,
wherein the controller displays the image indicating that the shortcut menus to which the first visual effect is applied are disposed in the folder and the image indicating the number of the shortcut menus to which the first visual effect is applied so as to overlap an image of the folder, and
wherein the controller displays the image of the folder.

19. The electronic device as claimed in claim 11, wherein the controller calculates an operation time from an execution of the application to a termination of the application, and
wherein the controller counts the accumulation points for the application in consideration of the operation time when the accumulation points are calculated.

20. The electronic device as claimed in claim 19, wherein the controller increases the accumulation points as the operation time becomes longer.
